(19) United States
(12) Patent Application Publication
(10) Pub. No.: US 2026/0134196 A1
(43) Pub. Date: May 14, 2026

(54) ARTICLE GENERATION METHOD AND APPARATUS, AND COMPUTER READABLE STORAGE MEDIUM

(71) Applicant: Beijing Zitiao Network Technology Co., Ltd., Haidian District, Beijing (CN)

(72) Inventor: Kunqiong WU, Beijing (CN)

(21) Appl. No.: 19/118,097

(22) PCT Filed: Jun. 25, 2024
(86) PCT No.: PCT/CN2024/101377

§ 371 Date: Apr. 3, 2025

(51) Int. Cl. G06F 40/166; G06F 16/334; G06F 16/34; G06F 16/9535; G06F 40/289

(52) U.S. Cl. CPC G06F 40/166; G06F 16/3347; G06F 16/345; G06F 16/9535; G06F 40/289

(57) ABSTRACT

The present disclosure relates to an article generation method, an article generation apparatus, and a computer-readable medium, and relates to the field of computer technology. The article generation method includes: generating target text according to summaries of a plurality of first articles that are interrelated in themes, wherein at least one first article of the plurality of first articles comprises a first text paragraph and a first picture; for the at least one first article, determining a first degree of association between the first text paragraph and the first picture comprised therein; according to the target text and the first degree of association, determining a first picture corresponding to at least one second text paragraph of the target text as a second picture; and according to the target text and the second picture, generating a second article.

### TECHNICAL FIELD

The present disclosure relates to the field of computer technology, and in particular, to an article generation method and apparatus, and a computer-readable storage medium.

### BACKGROUND

With the vigorous development of the mobile Internet technology, a large number of articles are gathered in various information flow platforms, providing a variety of choices for users. Sometimes, content creators all tend to create articles around the same hot topic to attract traffic, with severe content homogenization. The users need to read a plurality of articles with the same topic, refine and integrate contents by himself, to obtain required information.

Moreover, single text content will make the user feel bored, so that it is difficult to attract attention of the user.

### SUMMARY

In view of this, embodiments of the present disclosure provide an article generation method and apparatus, and a computer-readable storage medium, whereby target text is generated according to summaries of a plurality of first articles, and according to a first degree of association between a first text paragraph and a first picture comprised in the first article, a picture is matched for the generated target text, thereby generating a better article where the picture and the text are mixed, improving interest of users in reading.

According to a first aspect of some embodiments of the present disclosure, there is provided an article generation method, comprising: generating target text according to summaries of a plurality of first articles that are interrelated in themes, wherein at least one first article of the plurality of first articles comprises a first text paragraph and a first picture; for the at least one first article, determining a first degree of association between the first text paragraph and the first picture comprised therein; according to the target text and the first degree of association, determining a first picture corresponding to at least one second text paragraph of the target text as a second picture; and according to the target text and the second picture, generating a second article.

According to a second aspect of some embodiments of the present disclosure, there is provided an article generation apparatus, comprising: a text generation module configured to generate target text according to summaries of a plurality of first articles that are interrelated in themes, wherein at least one first article of the plurality of first articles comprises a first text paragraph and a first picture; an degree of association determination module configured to, for the at least one first article, determine a first degree of association between the first text paragraph and the first picture comprised therein; a picture determination module configured to, according to the target text and the first degree of association, determine a first picture corresponding to at least one second text paragraph of the target text as a second picture; and an article generation module configured to, according to the target text and the second picture, generate a second article.

According to a third aspect of the present disclosure, there is provided an article generation apparatus, comprising: a memory; and a processor coupled to the memory, the processor being configured to perform, based on instructions stored in the memory, the article generation method according to any of some embodiments of the present disclosure.

According to a fourth aspect of the present disclosure, there is provided a computer-readable storage medium having thereon stored computer program instructions which, when executed by a processor, implement the article generation method according to any of some embodiments of the present disclosure.

According to a fifth aspect of the present disclosure, there is provided a computer program product, comprising computer program instructions which, when executed by a processor, implement the article generation method according to any of the embodiments of the present disclosure.

The “SUMMARY” is provided to introduce concepts in a simplified form, which will be described in detail below in the following “DETAILED DESCRIPTION”. The “SUMMARY” is not intended to identify key features or essential features of the claimed technical solutions, nor is it intended to limit the scope of the claimed technical solutions.

Other features of the present disclosure and advantages thereof will become apparent from the following detailed description of exemplary embodiments thereof, which proceeds with reference to the accompanying drawings.

### BRIEF DESCRIPTION OF THE DRAWINGS

Preferred embodiments of the present disclosure are described below with reference to the accompanying drawings. The accompanying drawings described here are intended to provide a further understanding of the present disclosure, and the drawings, together with the specific description below, are incorporated in and form a part of this specification for explaining the present disclosure. It should be understood that the drawings in the following description only relate to some embodiments of the present disclosure and do not limit the present disclosure. In the drawings:

FIG. 1 illustrates a schematic flow diagram of an article generation method according to some embodiments of the present disclosure;

FIG. 2A illustrates a method of generating target text according to some embodiments of the present disclosure;

FIG. 2B illustrates a schematic diagram of determining a second picture according to some embodiments of the present disclosure;

FIG. 2C illustrates a schematic diagram of determining a second picture according to other embodiments of the present disclosure;

FIG. 3 illustrates a schematic diagram of a user interface according to some embodiments of the present disclosure;

FIG. 4 illustrates a schematic diagram of generating a paragraph summary according to some embodiments of the present disclosure;

FIG. 5 illustrates a schematic diagram of determining a second picture according to further embodiments of the present disclosure;

FIG. 6 illustrates a block diagram of an article generation apparatus according to some embodiments of the present disclosure;

FIG. 7 illustrates a block diagram of an article generation apparatus according to other embodiments of the present disclosure;

FIG. 8 illustrates a block diagram of an electronic device according to some embodiments of the present disclosure.

It should be understood that dimensions of various parts shown in the drawings are not necessarily drawn to an actual scale for ease of illustration. The same or similar reference numbers are used throughout the drawings to represent the same or similar components. Thus, once a certain item is defined in one drawing, it may not be further discussed in subsequent drawings.

### DETAILED DESCRIPTION

The technical solutions in the embodiments of the present disclosure will be described clearly and completely in conjunction with the drawings in the embodiments of the present disclosure, but it is obvious that the described embodiments are only some of the embodiments of the present disclosure, not all of the embodiments. The following description of the embodiments is merely illustrative in nature and is in no way intended to limit this disclosure and its application or use. It should be understood that the present disclosure may be implemented in various forms and should not be construed as limited to the embodiments set forth herein.

It should be understood that various steps recited in method embodiments of the present disclosure may be performed in a different order, and/or performed in parallel. Moreover, the method embodiments may comprise additional steps and/or omit performing the illustrated steps. The scope of the present disclosure is not limited in this respect. Unless specifically stated otherwise, the relative arrangement of the components and steps, numerical expressions, and numerical values set forth in these embodiments should be construed as merely exemplary and not limiting the scope of the present disclosure.

The term “comprise” and variations thereof used in this disclosure are intended to be open-ended terms that comprise at least the following elements/features, but do not exclude other elements/features, i.e., “comprising but not limited to”. Furthermore, the term “include” and variations thereof used in this disclosure are intended to be open-ended terms that include at least the following elements/features, but do not exclude other elements/features, i.e., “including but not limited to”. Thus, “comprise” is synonymous with “include”. The term “based on” means “based at least in part on”.

“One embodiment”, “some embodiments”, or “an embodiment” termed throughout this description means a specific feature, structure, or characteristic described in conjunction with the embodiments is comprised in at least one embodiment of the present invention. For example, the term “one embodiment” means “at least one embodiment”; the term “another embodiment” means “at least one additional embodiment”; and the term “some embodiments” means “at least some embodiments”. Moreover, the phrase “in one embodiment”, “in some embodiments”, or “in an embodiment”, which appears in various places throughout this description, does not necessarily refer to the same embodiment, but may refer to the same embodiment.

It should be noted that the notions such as “first” and “second” mentioned in the present disclosure are only used for distinguishing different devices, modules or units, and are not used for limiting the order or interdependence of functions performed by the devices, modules or units. Unless otherwise specified, the notions such as “first” and “second” are not intended to imply that the objects so described must be in a given order in time, space, ranking, or any other way.

It should be noted that the modifications of “a” and “a plurality” mentioned in the present disclosure are intended to be illustrative rather than restrictive, and that those skilled in the art should appreciate that they should be understood as “one or more” unless otherwise explicitly stated in the context.

Names of messages or information exchanged between a plurality of devices in the implementations of the present disclosure are for illustrative purposes only, and are not intended to limit the scope of the messages or information.

The embodiments of the present disclosure will be described in detail below in conjunction with the accompanying drawings, but the present disclosure is not limited to these specific embodiments. These specific embodiments below may be combined with each other, so that the same or similar concepts or processes may not be repeated in some embodiments. Furthermore, in one or more embodiments, a specific feature, structure, or characteristic may be combined in any suitable manner which would be apparent to one of ordinary skill in the art from this disclosure.

At present, there lacks a research on automatic picture matching technique for an article, so that it is difficult to meet a reading requirement of a user. The embodiments of the present disclosure provide an article generation method and apparatus, and a computer-readable storage medium, whereby target text is generated according to summaries of a plurality of first articles, and according to a first degree of association between a first text paragraph and a first picture comprised in the first article, a picture is matched for the generated target text, thereby generating a better article where the picture and the text are mixed, improving interest of users in reading.

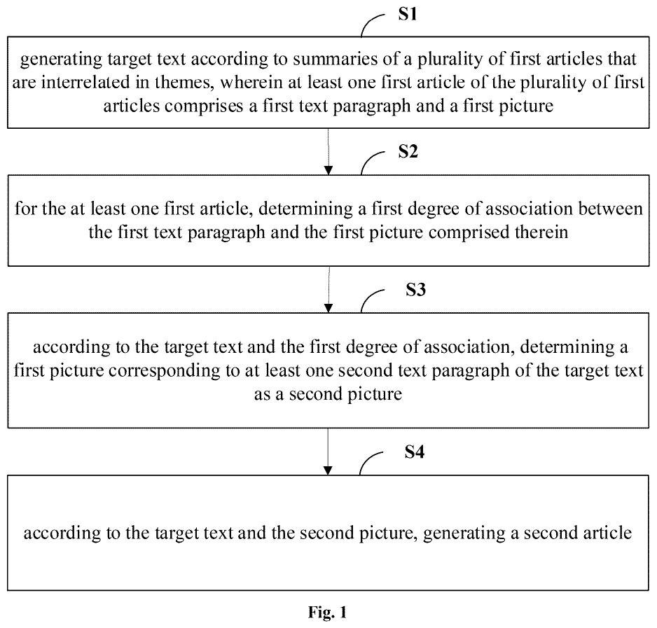

FIG. 1 illustrates a schematic flow diagram of an article generation method according to some embodiments of the present disclosure.

As shown in FIG. 1, the article generation method comprises: step S1, generating target text according to summaries of a plurality of first articles that are interrelated in themes, wherein at least one first article of the plurality of first articles comprises a first text paragraph and a first picture; step S2, for the at least one first article, determining a first degree of association between the first text paragraph and the first picture comprised therein; step S3, according to the target text and the first degree of association, determining a first picture corresponding to at least one second text paragraph of the target text as a second picture; and step S4, according to the target text and the second picture, generating a second article.

The article generation method of some embodiments may be executed on a client, or partially executed on a server.

The first article is, for example, an article written by an author. The at least one first article comprises both a text portion (i.e., the first text paragraph) and a matched picture (i.e., the first picture). That is, the first picture is an original picture in the first article.

The first article is, for example, an article in science and technology, game, fashion, sports, and other fields. Taking the sports field as an example, a theme of the first article is, for example, the World Cup, the Olympics, a championship, etc.

The first degree of association between the first text paragraph and the first picture represents a correlation between content of the first text paragraph and content of the first picture.

The second article comprises the target text and the second picture. According to some embodiments of the present disclosure, text in the second article is generated according to the text in the first article, and by the degree of association between the picture and the text in the original first article, a picture is matched for the newly generated second article, improving a correlation between the picture and the text in the second article, and the better second article where the picture and the text are mixed can be obtained.

Meanwhile, by integrating the text summaries of the plurality of first articles, the text of the second article is generated, so that multi-article fusion and creation are implemented, and the requirement of a user for efficient acquisition of information is met.

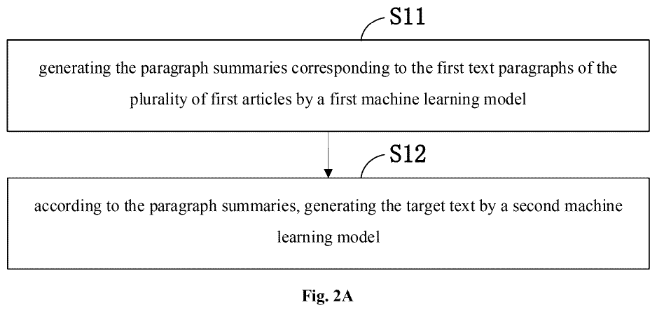

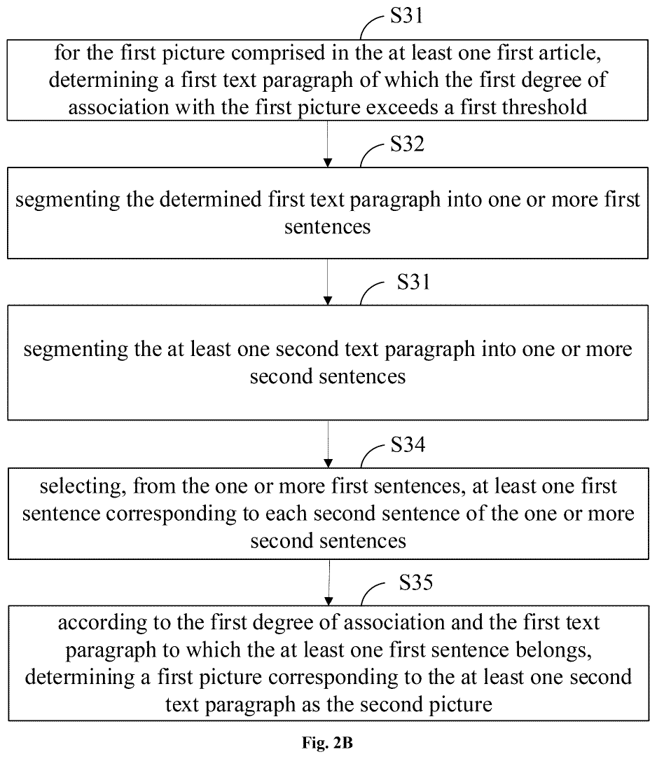

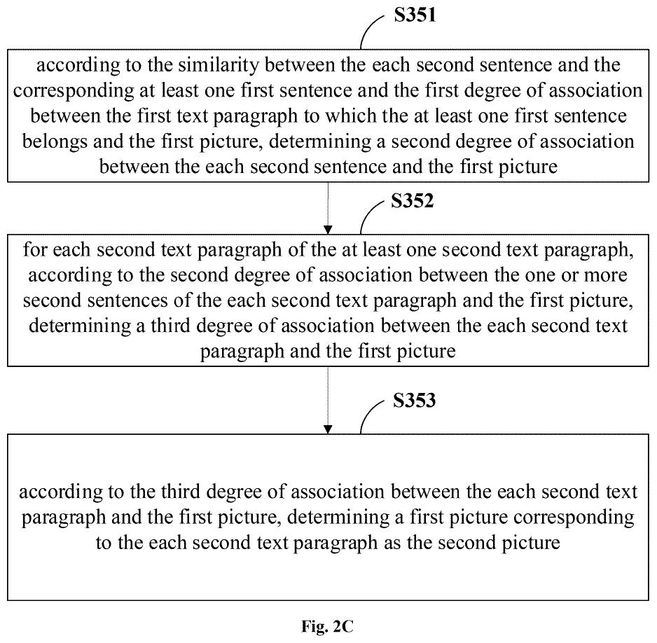

A method of integrating a plurality of first articles to generate target text according to some embodiments of the present disclosure is first described below in conjunction with FIG. 2A.

The summaries of the plurality of first articles comprise paragraph summaries corresponding to the first text paragraphs of the plurality of first articles, as shown in FIG. 2A, the step S1 of generating target text according to summaries of a plurality of first articles that are interrelated in themes comprises: step S11, generating the paragraph summaries corresponding to the first text paragraphs of the plurality of first articles by a first machine learning model; and step S12, according to the paragraph summaries, generating the target text by a second machine learning model.

For example, for one first article having a plurality of first text paragraphs, a paragraph summary is generated for each of the first text paragraphs therein. The paragraph summary may comprise part of key content of the first text paragraph, or may be reformulation of a distilled main idea or key information of the first text paragraph. By summarizing each first text paragraph, loss of key information of the first article can be reduced while the contents of the plurality of first articles can be integrated and compressed.

In some embodiments, a maximum input length of the first machine learning model is greater a maximum input length of the second machine learning model.

For example, the second machine learning model has a limit on the length of input text, so that if the plurality of first article texts are spliced and then directly input into the second machine learning model, the maximum input length allowed by the second machine learning model may be exceeded. By firstly generating the paragraph summaries using the first machine learning model to distil the core contents, the information of the plurality of first articles is compressed and simplified, thereby helping to generate the target text by the second machine learning model subsequently.

The first machine learning model is, for example, a large language model (LLM), and the second machine learning model is, for example, a dialogue generation Model.

In some embodiments, the according to the paragraph summaries, generating the target text by a second machine learning model comprises: according to the paragraph summaries, generating an outline of the second article by a third machine learning model; and according to the outline of the second article, generating the target text by the second machine learning model.

For example, the paragraph summaries of the plurality of first articles are spliced together, and an outline of a second article is generated according to the spliced paragraph summaries by a third machine learning model. According to the outline, the target text is generated by the second machine learning model.

According to some embodiments above of the present disclosure, information of a plurality of first articles is integrated first, and then text is perfected around an outline, so that this creation process is closer to a process where an article is created, enabling a more reasonable structure of a generated second article, and enhancing continuity and logicality of the content.

By distilling the outline using a model to bring different contents, viewpoints, perspectives and the like of the plurality of first articles together, re-creation of the contents is realized, so that the second article provides more comprehensive information. A total word count of the outline is, for example, less than that of the paragraph summaries of the plurality of first articles, so that while the article architecture is determined, the information is further compressed and simplified, meeting the requirement of the second machine learning model for the input text length.

In some embodiments, the according to the outline of the second article, generating the target text by the second machine learning model, comprises: according to the outline of the second article and a specified theme, generating the target text by the second machine learning model.

For example, it is desired that a theme of the generated target text is pre-specified. By generating the target text according to the outline of the second article and a specified theme, the content of the generated target text is more closely around the specified theme. The specified theme of the second article may also be taken from the theme of the first article.

In some embodiments, the article generation method further comprises, before the generating the target text according to summaries of a plurality of first articles that are interrelated in themes, determining a theme of each first article of the plurality of first articles.

For example, related articles are searched for around a hotspot word. Then, content is recalled to obtain a set of some articles meeting user interest. Themes of the articles in the set are acquired by text clustering and the like. For first articles with different themes, articles with the same theme can be classified together. When the first article is screened, the articles with the same theme are selected as a plurality of first articles. When the first articles are screened, a similarity between different themes can also be calculated, so that the plurality of first articles are first articles of which a similarity between themes exceeds a threshold.

In some embodiments, the generating the paragraph summaries corresponding to the first text paragraphs of the plurality of first articles by a first machine learning model, comprises: for the first text paragraph of the each first article of the plurality of first articles, according to a current first text paragraph and a paragraph summary corresponding to a preceding paragraph before the current first text paragraph, generating a paragraph summary corresponding to the current first text paragraph by the first machine learning model.

For example, when the paragraph summary of each first text paragraph is generated, in addition to the text of the first text paragraph, a paragraph summary of text of a previous first text paragraph is also considered. Compared with only dependence on the current paragraph, this method provides more information for the first machine learning model, deepening the understanding of the current paragraph by the model, thereby making the generated paragraph summary more accurate and reducing information loss in the text compression process from the paragraph to the paragraph summary.

In some embodiments, the generating the paragraph summaries corresponding to the first text paragraphs of the plurality of first articles by a first machine learning model, comprises: for the first text paragraph of the each first article, according to the current first text paragraph, the paragraph summary corresponding to the preceding paragraph, and partial text in the preceding paragraph, generating the paragraph summary corresponding to the current first text paragraph by the first machine learning model.

For example, when the paragraph summary of the each first text paragraph is generated, in addition to the text of the first text paragraph and the paragraph summary of text of the previous first text paragraph, partial text of the previous first text paragraph is also considered, so that more information is provided for the first machine learning model, making the generated paragraph summary more accurate, and further reducing information loss in the text compression process from the paragraph to the paragraph summary.

In some embodiments, for the first text paragraph of the each first article, according to the current first text paragraph, the paragraph summary corresponding to the preceding paragraph, and partial text in the preceding paragraph, generating the paragraph summary corresponding to the current first text paragraph by the first machine learning model, comprises: according to the current first text paragraph, the summary of the preceding paragraph, and partial text in the preceding paragraph that is adjacent to the current first text paragraph, generating the paragraph summary corresponding to the current first text paragraph by the first machine learning model.

For example, if a word count threshold is set to 1000 words and a text length of the current first text paragraph is 800 words, last 200 words of a previous first text paragraph are taken and spliced together with the 800 words of the current first text paragraph to jointly serve as an input of the first machine learning model. That is, when paragraph summaries are generated for two adjacent first text paragraphs, respectively, taken text is partially overlapped, thereby further reducing information loss in the text compression process from the paragraph to the paragraph summary.

The partial text of the previous first text paragraph may also be a randomly selected partial text, for example, if a word count threshold is set to 1000 words and a text length of the current first text paragraph is 800 words, successive 200 words at a random position of the previous first text paragraph are taken and spliced together with the 800 words of the current first text paragraph to jointly serve as an input of the first machine learning model.

A method of determining a second picture according to some embodiments of the present disclosure is described below in conjunction with FIGS. 2B-2C.

As shown in FIG. 2B, the step S3 of, according to the target text and the first degree of association, determining a first picture corresponding to at least one second text paragraph of the target text as a second picture, comprises: step S31, for the first picture comprised in the at least one first article, determining a first text paragraph of which the first degree of association with the first picture exceeds a first threshold; step S32, segmenting the determined first text paragraph into one or more first sentences; step S33, segmenting the at least one second text paragraph into one or more second sentences; step S34, selecting, from the one or more first sentences, at least one first sentence corresponding to each second sentence of the one or more second sentences; and step S35, according to the first degree of association and the first text paragraph to which the at least one first sentence belongs, determining a first picture corresponding to the at least one second text paragraph as the second picture.

For example, for the at least one first article comprising the picture and the generated target text, sentence segmentation is performed, respectively. First sentences corresponding to a second sentence in the target text are selected, and according to a first degree of association between the first text paragraph from which these corresponding first sentences source and one first picture, a first picture related to the content of the second text paragraph is determined as the second picture.

In some embodiments, for the at least one first article of the plurality of first articles, determining a first degree of association between the first text paragraph and the first picture comprised therein, comprises: according to a relative position between the first text paragraph and the first picture in the plurality of first articles, determining the first degree of association between the first text paragraph and the first picture.

For example, the closer the first text paragraph is to the first picture ‘a’, the higher the first degree of association with the first picture ‘a’. If after one first text paragraph, there are a plurality of successive pictures (with no text inserted therebetween), a distance between the plurality of pictures and the first text paragraph may be distinguished no longer. That is, first degrees of association of the first text paragraph with the plurality of pictures are the same, all of which is the highest. Alternatively, the distance between the first text paragraph and the plurality of succeeding pictures may be further distinguished, for example, an degree of association between a first picture after the first text paragraph and the first text paragraph is the highest, an degree of association between a second picture after the first text paragraph and the first text paragraph is the second highest, and so on.

Generally, when creating the first article, an author has already made evaluation when mixing the picture and the text, so that a picture between paragraphs not only is inserted around the theme of the article, but also combines content discussed in a paragraph near the picture. Generally, a picture and a nearest paragraph of the picture are in association and have a closest relation.

In some embodiments above of the present disclosure, mapping between the picture and the paragraph is established by the first degree of association in the first article. Then, by comparing the paragraph in the first article with the paragraph in the second article and combining the mapping between the picture and the paragraph in the first article, a correspondence between the paragraph in the second article and the picture in the first article is found, thereby matching a picture for the second article.

Compared with analyzing a picture semantic by an artificial intelligent picture model, in the above manner of matching a picture for the second article, the requirement for picture analysis is converted into analysis on text, reducing calculation cost and improving efficiency.

In some embodiments, the selecting, from the one or more first sentences, at least one first sentence corresponding to each second sentence of the one or more second sentences, comprises: determining a similarity between the each second sentence and the one or more first sentences; and according to the similarity between the each second sentence and the one or more first sentences, selecting the at least one first sentence corresponding to the each second sentence.

For example, a first sentence of which the similarity with the second sentence exceeds a threshold is determined as a first sentence corresponding to the second sentence. As mentioned above, the mapping between the picture and the paragraph is established by the first article, the similarity between the paragraph in the first article and the sentence in the second article is compared for picture matching, so that the requirement for picture analysis is converted into analysis on text. Compared with analyzing a picture semantic by the artificial intelligence picture model, the text analysis has higher calculation speed and lower resource consumption. Moreover, Compared with a picture understanding capability of the current artificial intelligence model being not ideal enough, the code engineering means for comparative analysis between text and text has better stability and accuracy.

In some embodiments, the determining a similarity between the each second sentence and the one or more first sentences, comprises: determining a vector of the each second sentence; determining a vector of each first sentence of the one or more first sentences; and according to the vector of the each second sentence and the vector of the each first sentence, determining the similarity between the each second sentence and the each first sentence.

For example, the first sentence and the second sentence are respectively converted into vectors, the vector of the first sentence is stored into a vector database, query in the vector database is performed by using the vector of the second sentence, and first Y first sentences with a high similarity are used as corresponding first sentences. The similarity between the first sentence and the second sentence is determined by calculating the similarity between the vectors. Y is a positive integer.

Compared with converting each paragraph in its entirety into a vector, vectorizing each sentence separately can preserve more information. Because dimensions of a vector which a model can calculate are limited, in the limited dimensions, the text is segmented and then converted, so that the obtained vector can contain more complete semantics, with higher interpretation of the original text, thereby making the calculated similarity more accurate, and enabling more accurate picture matching for the second text.

Meanwhile, compared with analyzing a semantic of a picture by an artificial intelligent model, the code engineering means for text vector analysis has better stability and accuracy.

FIG. 2C illustrates a schematic diagram of determining a second picture according to other embodiments of the present disclosure.

As shown in FIG. 2C, the step S35 of, according to the first degree of association and the first text paragraph to which the at least one first sentence belongs, determining a first picture corresponding to the at least one second text paragraph as the second picture, comprises: step S351, according to the similarity between the each second sentence and the corresponding at least one first sentence and the first degree of association between the first text paragraph to which the at least one first sentence belongs and the first picture, determining a second degree of association between the each second sentence and the first picture; step S352, for each second text paragraph of the at least one second text paragraph, according to the second degree of association between the one or more second sentences of the each second text paragraph and the first picture, determining a third degree of association between the each second text paragraph and the first picture; step S353, according to the third degree of association between the each second text paragraph and the first picture, determining a first picture corresponding to the each second text paragraph as the second picture.

For example, for first pictures ‘a’ and ‘b’, and a second sentence ‘A’ in a second text paragraph ‘p1’, a second degree of association between the second sentence ‘A’ and the first picture ‘a’ is first determined according to a similarity between the second sentence ‘A’ and a corresponding first sentence, and a first degree of association between a first text paragraph from which the first sentence corresponding to the second sentence ‘A’ sources and the first picture ‘a’. Then, second degrees of association of all the second sentences of the second text paragraph ‘p1’ with the first picture ‘a’ are counted, thereby obtaining a third degree of association between the second text paragraph ‘p1’ and the first picture ‘a’. Similarly, a third degree of association between the second text paragraph ‘p1’and the first picture ‘b’can be obtained.

In some embodiments, the second degree of association is in positive correlation with the similarity; the second degree of association is in positive correlation with the first degree of association; and/or the third degree of association of the each second text paragraph is a weighted sum of the second degrees of association between the one or more second sentences of the each second text paragraph and the first picture.

For example, the second sentence ‘A’ corresponds to a first sentence 1, a first sentence 2, and a first sentence 3, then a product of a similarity between the second sentence ‘A’ and the first sentence 1 and a first degree of association between a paragraph where the first sentence 1 is located and the first picture ‘a’ is calculated. For the second sentence ‘A’, its corresponding products with the first sentence 1, the first sentence 2 and the first sentence 3 are respectively calculated, and a weighted sum of these products is calculated to obtain a second degree of association between the second sentence ‘A’and the first picture ‘a’.

Then, a weighted sum of second degrees of association of all second sentences of the second text paragraph ‘p1’ with the first picture ‘a’ is calculated to obtain a third degree of association between the second text paragraph ‘p1’and the first picture ‘a’.

In some embodiments, the according to the third degree of association between the each second text paragraph and the first picture, determining a first picture corresponding to the each second text paragraph as the second picture, comprises: among first pictures of which the third degree of association with the each second text paragraph exceeds a second threshold, determining N first pictures of which the third degrees of association with the each second text paragraph are in top N, as the second picture corresponding to the each second text paragraph, where N is a specified positive integer.

For example, a count threshold N is set, and each paragraph is matched with N pictures at most. If a count of first pictures of which the third degree of association with a second text paragraph exceeds the second threshold is greater than N, N first pictures (hereinafter referred to as candidate pictures) of which the third degree of association with the second text paragraph is the highest are selected as a second picture corresponding to the second text paragraph.

When a plurality of second text paragraphs have a same candidate picture, the same candidate picture is used as a second picture of a second text paragraph of which the third degree of association with the candidate picture is the highest, and a second picture corresponding to other second text paragraph(s) do not comprise the same candidate picture.

When the second pictures are assigned, third degrees of association between all second text paragraphs in the second article and a plurality of first pictures may be first calculated. Then, the pictures are assigned in a descending order of the third degrees of association of all the second text paragraphs in the second article. A first picture has already been assigned to a certain second text paragraph will not be assigned to other second text paragraph(s), thereby avoiding picture duplication.

In some embodiments, the according to the target text and the second picture, generating a second article, comprises: for other second text paragraph(s) of the target text, generating a third picture corresponding to the other second text paragraph, according to the other second text paragraph by a fourth machine learning model, in response to there being no first picture, of which third degree of association exceeds the second threshold for the other second text paragraph; and generating the second article, according to the target text, the second picture, and the third picture.

The fourth machine learning model is a picture generation model. If there is a second text paragraph ‘p2’ of which the third degree of association with the first picture does not exceed the second threshold, that is, no suitable picture matched for the second text paragraph ‘p2’ is found in the first article, then a picture is generated according to a text content of the second text paragraph ‘p2’ by the fourth machine learning model, as a picture matched for the second text paragraph ‘p2’. Alternatively, it is also possible to first extract a core semantic and/or discussion object from the second text paragraph ‘p2’ by a natural language processing model, and then generate a third picture around the core semantic and/or discussion object of this paragraph by the fourth machine learning model. The third picture is used as a supplement to the second picture, so that the content of the generated second article is richer.

In some embodiments, the according to the target text and the second picture, generating a second article, comprises: for the each second text paragraph of the at least one second text paragraph, determining a position that the corresponding second picture is inserted into the each second text paragraph according to at least one of the second degree of association between the one or more second sentences and the corresponding first picture, a size of a display page for the second article, a size of a maximum area in the display page where text occupies, a size of a maximum area where a picture occupies, a number of the first picture(s) corresponding to the each second text paragraph, or a size of the first picture corresponding to the each second text paragraph.

For example, according to a screen size of a mobile device of a user and personalized settings of a font and display by the user, on one page of the screen, 500 words at most are displayed, or 300 words and one picture at most are simultaneously displayed. A second text paragraph has 800 words and corresponds to one picture, then the one picture and 300 words are displayed on one same page, and the other 500 words are displayed on another page.

At the mobile terminal, when picture-and-text layout is performed on the second article, by adjusting the position that the second picture is inserted into the second text paragraph, at least part of the content of the second text paragraph and the corresponding second picture are displayed in the same page, so that the user does not need to perform page turning for related paragraphs and pictures back and forth.

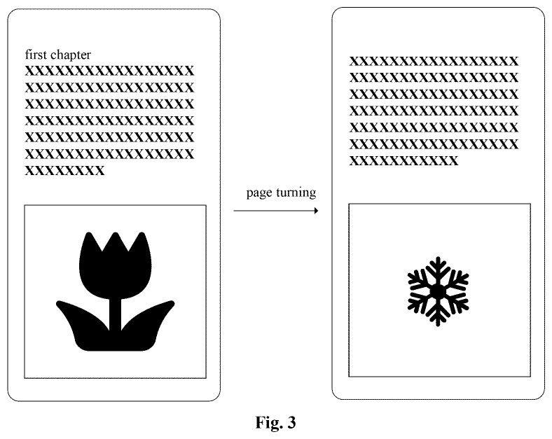

FIG. 3 illustrates a schematic diagram of a user interface according to some embodiments of the present disclosure.

As shown in FIG. 3, if one second text paragraph corresponds to two second pictures and one page of a screen cannot have therein completely displayed all contents of the second text paragraph, the second text paragraph is, by using the picture, segmented into two parts which are respectively displayed on two pages, so that the first page and the second page have respective text and matched pictures. When reading, the user can not feel bored because the whole screen is filled with the text, so that interest in an article is enhanced.

In some embodiments, the according to the target text and the second picture, generating a second article, comprises: after the each second text paragraph of the at least one second text paragraph, inserting the corresponding second picture.

For example, when picture-and-text layout is performed on the second article, the second picture is inserted immediately after the corresponding second text paragraph, so that the user can immediately make visual reference through the picture after reading the paragraph, deepening the impression and better understanding the main idea or details of the paragraph.

In some embodiments, the article generation method further comprises: acquiring a theme of the target text; and selecting, from the plurality of text paragraphs in the second article, at least one text paragraph of which the fourth degree of association with the theme exceeds a threshold, as the at least one second text paragraph.

For example, a theme of the target text is determined by a theme extraction model, or a preset theme is acquired. The higher correlation of the second text paragraph with the theme, the more important the second text paragraph. Therefore, a paragraph with a high correlation with the theme is selected as a paragraph needing a picture for matching, which is beneficial to understanding of the article and grasp of the theme by the user.

The fourth degree of association is calculated, for example, by a text similarity calculation method.

In some embodiments, the article generation method further comprises: in response to a historical browsing history of the user comprising the plurality of first articles and/or articles related to the themes of the plurality of first articles, recommending the second article to the user.

For example, if a user has browsed a first article, or an article related to the first article, or an article related to a theme of a second article, the second article is pushed to the user, thereby providing a more personalized content to the user.

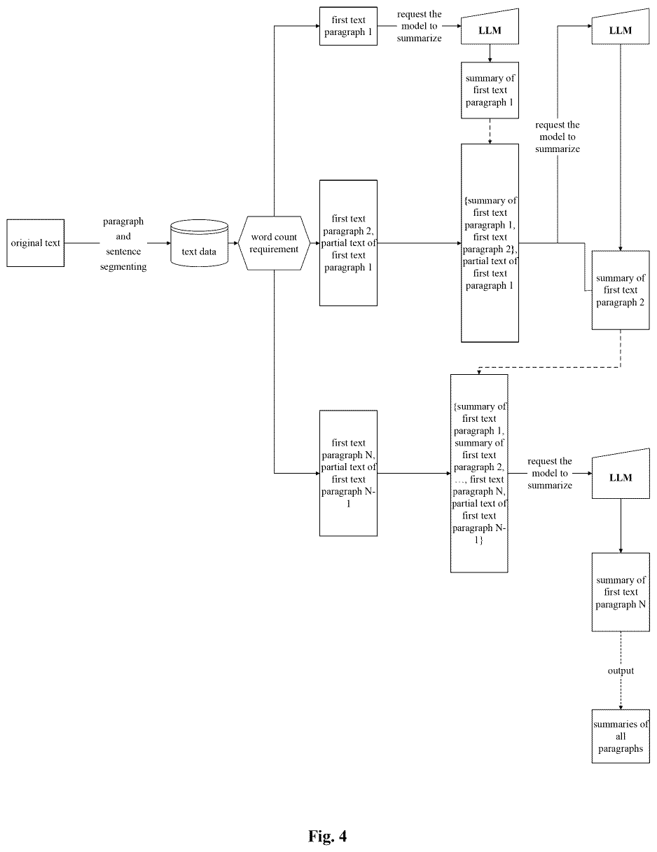

FIG. 4 illustrates a schematic diagram of generating a paragraph summary according to some embodiments of the present disclosure.

As shown in FIG. 4, original text in a first article is segmented paragraph by paragraph and sentence by sentence to obtain text data.

According to a word count requirement, text of each paragraph that is used for generating a summary is determined by an LLM model. The word count requirement is, for example, a requirement that a maximum count of words of each paragraph that are input into the LLM model, for example, a word count threshold is set to 1000 words, and a text length of a current first text paragraph is 800 words, then last 200 words of a previous first text paragraph are taken and spliced together with the 800 words of the current first text paragraph to jointly serve as an input of a first machine learning model.

The word count requirement may also be a requirement for a count of overlapped words between paragraphs, for example, an overlapped-word count is set to 300, then last 300 words of the previous first text paragraph are taken and spliced together with the current first text paragraph to jointly serve as an input of the LLM model.

For a first paragraph (i.e., a first text paragraph 1) in each first article, a summary of the first paragraph is generated by the LLM model by using text of the first paragraph.

Starting from a second paragraph, the current paragraph, partial text of a previous paragraph, and summaries of a plurality of preceding paragraphs are all used as the input of the LLM model to obtain a summary of the current paragraph. Based on this, the summary corresponding to each paragraph of all the paragraphs is obtained.

The summaries of all the paragraphs of all the first articles are spliced together and input into a third machine learning model to obtain an outline of a second article. The outline of the second article is input into a second machine learning model to generate target text where the word contents of the plurality of first articles are fused.

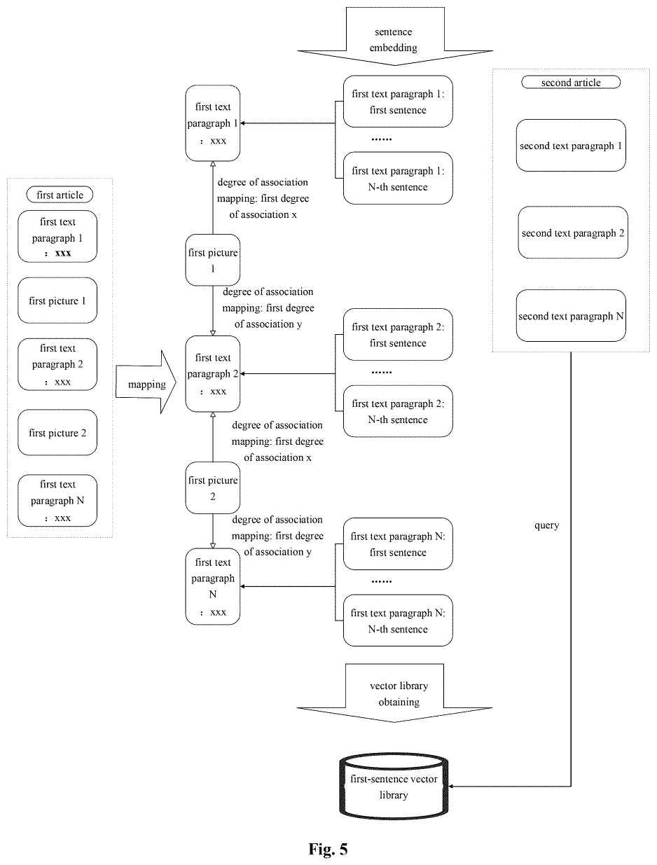

After the target text is generated, a picture is further inserted into the target text. A method of determining a second picture according to further embodiments of the present disclosure is described below in conjunction with FIG. 5.

Taking one first article as an example, an degree of association between a paragraph of the first article and an adjacent picture is first determined, thereby obtaining mapping between a first text paragraph and a first picture, where x and y may be the same or different. The first text paragraph is segmented into a plurality of first sentences, and a vector of each first sentence is calculated. Each second text paragraph of a second article is also segmented into a plurality of second sentences, and query in a sentence vector library is performed by using a vector of the second sentence, to find a similar first sentence, so that mapping between the first text paragraph and the second text paragraph is obtained. According to the mapping between the first text paragraph and the first picture and the mapping between the first text paragraph and the second text paragraph, a first picture corresponding to the second text paragraph is determined as a second picture.

If there are no first picture corresponding to a second text paragraph, a corresponding third picture may be generated according to text of the second text paragraph by a picture generation model.

After the second picture corresponding to the second text paragraph is determined, the second picture is inserted after the corresponding second text paragraph to complete the creation of the second article. If there is a third picture, the third picture is also inserted after the corresponding paragraph.

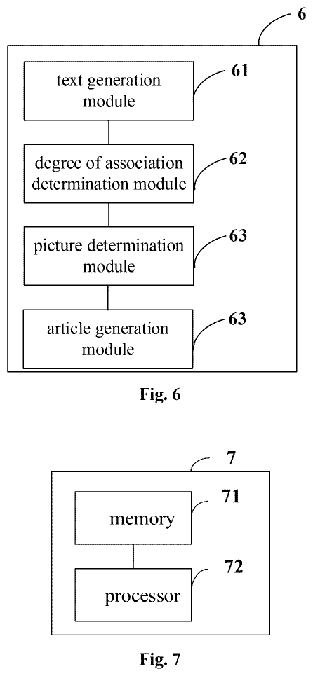

The above is the article generation method provided in some embodiments of the present disclosure. An article generation apparatus according to an embodiment of the present disclosure is described below with reference to FIGS. 6 to 8, which is used for performing any of the above article generation methods.

FIG. 6 illustrates a block diagram of an article generation apparatus according to some embodiments of the present disclosure.

As shown in FIG. 6, the article generation apparatus 6 comprises: a text generation module 61 configured to, generate target text according to summaries of a plurality of first articles that are interrelated in themes, wherein at least one first article of the plurality of first articles comprises a first text paragraph and a first picture; an degree of association determination module 62 configured to, for the at least one first article, determine a first degree of association between the first text paragraph and the first picture comprised therein; a picture determination module 63 configured to, according to the target text and the first degree of association, determine a first picture corresponding to at least one second text paragraph of the target text as a second picture; and an article generation module 64 configured to, according to the target text and the second picture, generate a second article.

The text generation module 61 of the article generation apparatus 6 may be configured to perform the step S1 of FIG. 1. The degree of association determination module 62 of the article generation apparatus 6 may be configured to perform the step S2 of FIG. 1. The picture determination module 63 of the article generation apparatus 6 may be configured to perform the step S3 of FIG. 1. The article generation module 64 of the article generation apparatus 6 may be configured to perform the step S4 of FIG. 1.

In some embodiments, the article generation apparatus 6 further comprises a paragraph selection module configured to: acquire a theme of the target text; and select, from the plurality of text paragraphs in the second article, at least one text paragraph of which the fourth degree of association with the theme exceeds a threshold, as the at least one second text paragraph.

In some embodiments, the article generation apparatus 6 further comprises a recommendation module configured to: in response to a historical browsing history of a user comprising the plurality of first articles and/or articles related to the themes of the plurality of first articles, recommend the second article to the user.

FIG. 7 shows a block diagram of an article generation apparatus according to other embodiments of the present disclosure.

As shown in FIG. 7, the article generation apparatus 7 comprises: a memory 71; and a processor 72 coupled to the memory 71, the processor 72 being configured to perform, based on instructions stored in the memory 71, the article generation method of any of the forgoing embodiments.

The memory 71 is configured to store one or more computer-readable instructions. The memory 71 may comprise any combination of various forms of computer-readable storage media, such as a volatile memory and/or non-volatile memory, comprising but not limited to a random access memory (RAM), dynamic random access memory (DRAM), static random access memory (SRAM), read-only memory (ROM), flash memory. The memory 71 may store, for example, an operating system, application, boot loader, database, other programs, and the like, and may also store various applications, various data, and the like.

The processor 72 is configured to execute the computer-readable instructions to implement the article generation method of any of the foregoing embodiments. For the specific implementation of each step of the article generation method, reference may be made to the foregoing embodiments, which are not repeated here.

The processor 72 may be configured to perform the steps S1-S4 of FIG. 1 or the steps S1′-S3′ of FIG. 7. The processor 72 may be embodied as various processing means such as a central processing unit (CPU), network processor (NP), etc. ; and may also be a digital signal processor (DSP), application specific integrated circuit (ASIC), field programmable gate array (FPGA) or other programmable logic device, discrete gate or transistor logic device, and discrete hardware component. The central processing unit (CPU) may be an X86 or ARM architecture, etc.

The processor 72 and the memory 71 may directly or indirectly communicate with each other. For example, the processor 72 and the memory 71 may communicate by a network. The network may comprise a wireless network, a wired network, and/or any combination of wireless and wired networks. The processor 72 and the memory 71 may also communicate with each other via a system bus, which is not limited by the present disclosure.

It should be noted that the components of the article generation apparatus 7 shown in FIG. 7 are only exemplary and not restrictive, and the article generation apparatus 7 may also have another component according to actual application requirements. The processor 72 may control the other component in the article generation apparatus 7 to perform a desired function.

The article generation apparatus may be implemented by software, firmware and/or hardware, and may be integrated in an electronic device installed with a related application.

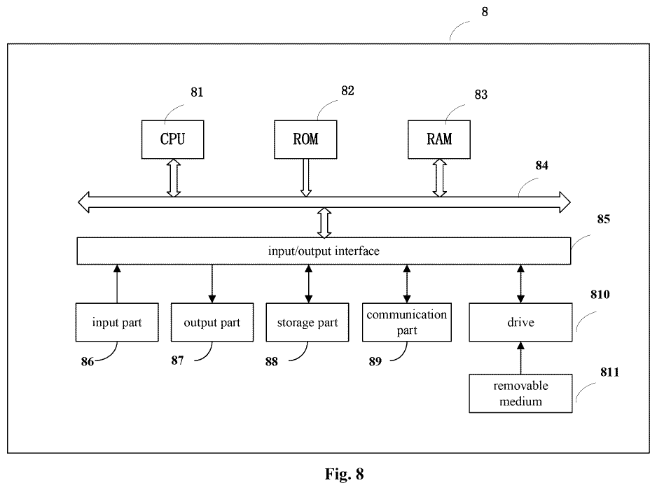

FIG. 8 illustrates a block diagram of an electronic device according to some embodiments of the present disclosure.

The electronic device 8 shown in FIG. 8 may be a computer system having a dedicated hardware structure, which can perform a corresponding function when installed with a related application.

The electronic device comprises, but is not limited to, a mobile terminal such as a smartphone, laptop, personal digital assistant (PDAs), Tablet personal computer (Tablet PC), PMP (Portable Multimedia Player), vehicle-mounted terminal (e.g., vehicle-mounted navigation terminal), and wearable device, and a fixed terminal such as a digital TV and desk computer.

As shown in FIG. 8, a central processing unit (CPU) 81 executes various processes according to a program stored in a read-only memory (ROM) 82 or a program loaded from a storage part 88 to a random access memory (RAM) 83. In the RAM 83, data required when the CPU 81 executes various processes and the like is stored as needed. The central processing unit is merely exemplary and may also be another type of processors, such as the various processors described above. The RO 82, RAM 83, and storage part 88 may be various forms of computer-readable storage media. It should be noted that although the ROM 82, RAM 83 and storage part 88 are shown separately in FIG. 8, one or more of them may be combined or located in the same or different memories or storage modules.

The CPU 81, ROM 82, and RAM 83 are connected with each other via a bus 84. An input/output interface 85 is also connected to the bus 84.

The following components are connected to the input/output interface 85: an input part 86, such as a touch screen, a touch pad, a keyboard, a mouse, an picture sensor, a microphone, an accelerometer, a gyroscope, etc.; an output part 87, comprising a display such as a cathode ray tube (CRT), a liquid crystal display (LCD), a speaker, a vibrator, etc. ; the storage part 88, comprising a hard disk, a magnetic tape, etc.; and a communication part 89, comprising a network interface card such as a LAN card and a modem. The communication part 89 allows communication processing to be performed via a network such as the Internet. It will be readily appreciated that while FIG. 8 shows that the various means or modules in the electronic device 8 communicate via the bus 84, they may also communicate via a network or in another way, wherein the network may comprise a wireless network, a wired network, and/or any combination of wireless and wired networks.

A drive 810 is also connected to the input/output interface 85 as needed. A removable medium 811 such as a magnetic disk, an optical disk, a magneto-optical disk, or a semiconductor memory is mounted onto the drive 810 as needed, so that a computer program read out therefrom is installed into the storage part 88 as needed.

When the above series of processes is implemented by software, a program constituting the software may be installed from a network such as the Internet or a storage medium such as the removable medium 811.

According to an embodiment of the present disclosure, the processes described above with reference to the flow diagrams may be implemented as a computer software program. For example, some embodiments of the present disclosure comprise a computer program product which, when run on a computer, causes the computer to implement the article generation method according to any of the foregoing embodiments. The computer program product comprises a computer program carried on a computer-readable medium, the computer program comprising program code for performing the method illustrated by the flow diagrams. In such an embodiment, the computer program may be downloaded and installed from a network through the communication part 89, or installed from the storage part 88, or installed from the ROM 82. When executed by the CPU 81, the computer program performs the article generation method of some embodiments of the present disclosure.

It should be noted that in the context of this disclosure, the computer-readable medium may be any tangible medium that can contain or store a program for use by or in conjunction with an instruction execution system, apparatus, or device.

The computer-readable medium may be a computer-readable storage medium or a computer-readable signal medium, or any combination of the above two.

The computer-readable storage medium comprises, but is not limited to: an electronic, magnetic, optical, electromagnetic, infrared, or semiconductor system, apparatus, or device, or any combination of the foregoing. More specific examples of the computer-readable storage medium may comprise, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium that contains or stores a program which can be used by or in conjunction with an instruction execution system, apparatus, or device. The computer-readable storage medium has thereon stored a computer program which, when executed by a processor, implements the article generation method according to any of the foregoing embodiments.

The computer-readable signal medium may comprise a data signal propagated in baseband or as part of a carrier wave, in which computer-readable program code is carried. Such a propagated data signal may take a variety of forms, comprising, but not limited to, an electromagnetic signal, optical signal, or any suitable combination of the forgoing. The computer-readable signal medium may also be any computer-readable medium other than the computer-readable storage medium, wherein the computer-readable signal medium can send, propagate, or transmit a program for use by or in conjunction with an instruction execution system, apparatus, or device. The program code contained on the computer-readable medium may be transmitted using any appropriate medium, comprising but not limited to: a wire, an optical cable, RF (Radio Frequency), etc., or any suitable combination of the foregoing.

The above computer-readable medium may be contained in the above electronic device; or may exist separately without being assembled into the electronic device.

In some embodiments, there is also provided a computer program, comprising: instructions which, when executed by a processor, cause the processor to perform the article generation method of any of the above embodiments. For example, the instructions may be embodied as computer program code.

In some embodiments of the present disclosure, computer program code for performing the operation of the present disclosure may be written in one or more programming languages or a combination thereof, wherein the above programming language comprises but is not limited to an object-oriented programming language such as Java, Smalltalk, and C++, and also comprises a conventional procedural programming language, such as a “C” language or a similar programming language. The program code may be executed entirely on a user's computer, partly on a user's computer, as a stand-alone software package, partly on a user's computer and partly on a remote computer, or entirely on a remote computer or server. In a scenario where a remote computer is involved, the remote computer may be connected to a user's computer through any type of network, comprising a local area network (LAN) or a wide area network (WAN), or may be connected to an external computer (for example, through the Internet using an Internet service provider).

The flow diagrams and block diagrams in the drawings illustrate the possibly implemented architecture, functions, and operations of the system, method and computer program product according to various embodiments of the present disclosure. In this regard, each block in the flow diagrams or block diagrams may represent a module, program segment, or part of code, which comprises one or more executable instructions for implementing a specified logical function. It should also be noted that, in some alternative implementations, functions noted in blocks may occur in a different order from those noted in the drawings. For example, two blocks shown in succession may, in fact, be executed substantially concurrently, or they may sometimes be executed in a reverse order, which depends upon the functions involved. It will also be noted that each block in the block diagrams and/or flow diagrams, and a combination of the blocks in the block diagrams and/or flow diagrams, can be implemented by a special-purpose hardware-based system that performs specified functions or operations, or by a combination of special-purpose hardware and computer instructions.

The functions described above may be performed, at least in part, by one or more hardware logic components. For example, without limitation, an exemplary hardware logic component that may be used comprises: a field programmable gate array (FPGA), application specific integrated circuit (ASIC), application specific standard product (ASSP), system on chip (SOC), complex programmable logic device (CPLD), and the like.

Although some specific embodiments of the present disclosure have been described in detail by the examples, it should be understood by those skilled in the art that the above examples are for illustration only and are not intended to limit the scope of the present disclosure. It should be appreciated by those skilled in the art that modifications can be made to the above embodiments without departing from the scope and spirit of the present disclosure. The scope of the present disclosure is defined by the appended claims.

1. An article generation method, comprising:
generating target text according to summaries of a plurality of first articles that are interrelated in themes, wherein at least one first article of the plurality of first articles comprises a first text paragraph and a first picture;
determining, for the at least one first article, a first degree of association between the first text paragraph and the first picture comprised therein;
determining the first picture corresponding to at least one second text paragraph of the target text as a second picture, according to the target text and the first degree of association; and
generating a second article according to the target text and the second picture.

2. The article generation method according to claim 1, wherein the summaries of the plurality of first articles comprise paragraph summaries corresponding to first text paragraphs of the plurality of first articles, and the generating target text according to summaries of the plurality of first articles that are interrelated in themes, comprises:
generating the paragraph summaries corresponding to the first text paragraphs of the plurality of first articles by a first machine learning model; and
generating the target text according to the paragraph summaries by a second machine learning model.

3. The article generation method according to claim 2, wherein the generating the target text by the second machine learning model, according to the paragraph summaries, comprises:
generating an outline of the second article according to the paragraph summaries by a third machine learning model; and
generating the target text according to the outline of the second article by the second machine learning model.

4. The article generation method according to claim 3, wherein the generating the paragraph summaries corresponding to the first text paragraphs of the plurality of first articles by the first machine learning model, comprises:
generating, for the first text paragraph of each first article of the plurality of first articles, a paragraph summary corresponding to the current first text paragraph, according to a current first text paragraph and a paragraph summary corresponding to a preceding paragraph before the current first text paragraph, by the first machine learning model.

5. The article generation method according to claim 4, wherein the generating the paragraph summaries corresponding to the first text paragraphs of the plurality of first articles by the first machine learning model, comprises:
generating, for the first text paragraph of the each first article, the paragraph summary corresponding to the current first text paragraph, according to the current first text paragraph, the paragraph summary corresponding to the preceding paragraph, and partial text in the preceding paragraph, by the first machine learning model.

6. The article generation method according to claim 5, wherein for the first text paragraph of the each first article, generating the paragraph summary corresponding to the current first text paragraph by the first machine learning model, according to the current first text paragraph, the paragraph summary corresponding to the preceding paragraph, and the partial text in the preceding paragraph, comprises:
generating the paragraph summary corresponding to the current first text paragraph, according to the current first text paragraph, the paragraph summary of the preceding paragraph, and the partial text that is adjacent to the current first text paragraph in the preceding paragraph, by the first machine learning model.

7. The article generation method according to claim 2, wherein a maximum input length of the first machine learning model is greater than a maximum input length of the second machine learning model.

8. The article generation method according to claim 1, wherein the determining the first picture corresponding to at least one second text paragraph of the target text as the second picture, according to the target text and the first degree of association, comprises:
determining, for the first picture comprised in the at least one first article, the first text paragraph, of which the first degree of association with the first picture exceeds a first threshold;
segmenting the determined first text paragraph into one or more first sentences;
segmenting the at least one second text paragraph into one or more second sentences;
selecting, from the one or more first sentences, at least one first sentence corresponding to each second sentence of the one or more second sentences; and
determining the first picture corresponding to the at least one second text paragraph as the second picture, according to the first degree of association and the first text paragraph, to which the at least one first sentence belongs.

9. The article generation method according to claim 8, wherein the selecting, from the one or more first sentences, at least one first sentence corresponding to each second sentence of the one or more second sentences, comprises:
determining a similarity between the each second sentence and the one or more first sentences; and
selecting the at least one first sentence corresponding to the each second sentence, according to the similarity between the each second sentence and the one or more first sentences.

10. The article generation method according to claim 9, wherein the determining the similarity between the each second sentence and the one or more first sentences, comprises:
determining a vector of the each second sentence;
determining a vector of each first sentence of the one or more first sentences; and
determining the similarity between the each second sentence and the each first sentence, according to the vector of the each second sentence and the vector of the each first sentence.

11. The article generation method according to claim 9, wherein the determining the first picture corresponding to the at least one second text paragraph as the second picture, according to the first degree of association and the first text paragraph to which the at least one first sentence belongs, comprises:
determining a second degree of association between the each second sentence and the first picture, according to the similarity between the each second sentence and corresponding at least one first sentence and the first degree of association between the first text paragraph, to which the at least one first sentence belongs and the first picture;
determining, for each second text paragraph of the at least one second text paragraph, a third degree of association between the each second text paragraph and the first picture, according to the second degree of association between the one or more second sentences of the each second text paragraph and the first picture; and
determining the first picture corresponding to the each second text paragraph as the second picture according to the third degree of association between the each second text paragraph and the first picture.

12. The article generation method according to claim 11, wherein:
the second degree of association is in positive correlation with the similarity;
the second degree of association is in positive correlation with the first degree of association; and/or
the third degree of association of the each second text paragraph is a weighted sum of the second degree of association between the one or more second sentences of the each second text paragraph and the first picture.

13. The article generation method according to claim 11, wherein the determining the first picture corresponding to the each second text paragraph as the second picture, according to the third degree of association between the each second text paragraph and the first picture, comprises:
determining, among first pictures of which the third degree of association with the each second text paragraph exceeds a second threshold, N first pictures of which third degrees of association with the each second text paragraph are in top N, as the second picture corresponding to the each second text paragraph, wherein N is a specified positive integer.

14. The article generation method according to claim 11, wherein the generating the second article, according to the target text and the second picture, comprises:
generating, for other second text paragraph(s) of the target text, a third picture corresponding to the other second text paragraph, according to the other second text paragraph by a fourth machine learning model, in response to there being no first picture, of which third degree of association exceeds the second threshold for the other second text paragraph; and
generating the second article, according to the target text, the second picture, and the third picture.

15. The article generation method according to claim 11, wherein the generating the second article according to the target text and the second picture, comprises:
determining, for the each second text paragraph of the at least one second text paragraph, a position that corresponding second picture is inserted into the each second text paragraph, according to at least one of the second degree of association between the one or more second sentences and corresponding first picture, a size of a display page for the second article, a size of a maximum area in the display page where text occupies, a size of a maximum area where a picture occupies, a number of the first picture(s) corresponding to the each second text paragraph, or a size of the first picture corresponding to the each second text paragraph.

16. The article generation method according to claim 1, wherein the generating the second article according to the target text and the second picture, comprises:
inserting corresponding second picture, after the each second text paragraph of the at least one second text paragraph.

17. The article generation method according to claim 1, wherein for the at least one first article of the plurality of first articles, determining the first degree of association between the first text paragraph and the first picture comprised therein, comprises:
determining the first degree of association between the first text paragraph and the first picture, according to a relative position between the first text paragraph and the first picture in the plurality of first articles.

18. The article generation method according to claim 1, further comprising:
acquiring a theme of the target text; and
selecting, from the plurality of text paragraphs in the second article, at least one text paragraph, of which a fourth degree of association with the theme exceeds a threshold, as the at least one second text paragraph; and/or
the article generation method further comprising: recommending the second article to a user, in response to a historical browsing history of the user comprising the plurality of first articles and/or articles related to the themes of the plurality of first articles.

19-20. (canceled)

21. An article generation apparatus, comprising:
a memory; and
a processor coupled to the memory, the processor being configured to perform, based on instructions stored in the memory, an article generation method, comprising:
generating target text according to summaries of a plurality of first articles that are interrelated in themes, wherein at least one first article of the plurality of first articles comprises a first text paragraph and a first picture;
determining, for the at least one first article, a first degree of association between the first text paragraph and the first picture comprised therein;
determining the first picture corresponding to at least one second text paragraph of the target text as a second picture, according to the target text and the first degree of association; and
generating a second article according to the target text and the second picture.

22. A non-transitory computer-readable storage medium having stored thereon computer program instructions which, when executed by a processor, implement an article generation method, comprising:
generating target text according to summaries of a plurality of first articles that are interrelated in themes, wherein at least one first article of the plurality of first articles comprises a first text paragraph and a first picture;
determining, for the at least one first article, a first degree of association between the first text paragraph and the first picture comprised therein;
determining the first picture corresponding to at least one second text paragraph of the target text as a second picture, according to the target text and the first degree of association; and
generating a second article according to the target text and the second picture.

23. (canceled)
